(19) United States
(12) Patent Application Publication
(10) Pub. No.: US 2005/0140641 A1
(43) Pub. Date: Jun. 30, 2005

(54) Power conservation for a display apparatus

(76) Inventors: Sang-Il Kim, Suwon-si (KR); Ung-Gyu Min, Namyangju-si (KR); Kyu-Ha Chung, Seoul (KR); Cheol-Woo Park, Suwon-si (KR); Jeong-Ye Choi, Suwon-si (KR); Chong-Chul Chai, Seoul (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 10/986,489

(22) Filed: Nov. 10, 2004

(30) Foreign Application Priority Data
Nov. 11, 2003 (KR) 2003-79501

(51) Int. Cl. G09G 3/36

(52) U.S. Cl. 345/102

(57) ABSTRACT

A method of controlling the backlight assembly of a display apparatus according to the ambient light level is presented. When there is sufficient ambient light to achieve a desired level of brightness in a display apparatus, the backlight assembly is turned off to conserve power. On the other hand, when the amount of ambient light is insufficient for achieving the desired brightness level, the backlight assembly is turned on to supplement the ambient light so that the display apparatus will provide the desired brightness level regardless of the amount of ambient light. In some embodiments, the intensity of the light emitted by the backlight assembly is adjusted according to the ambient light level. Optionally, the display apparatus is switched between transmissive mode and reflective mode depending on the ambient light level. The voltage applied to the display panel is adjusted depending on the operational mode.

### CROSS-REFERENCE TO RELATED APPLICATION

This application claims priority, under 35 U.S.C. § 119, from Korean Patent Application No. 2003-79501 filed on Nov. 11, 2003, the content of which is herein incorporated by reference in its entirety.

### BACKGROUND OF THE INVENTION

1. Field of the Invention

The invention relates generally to a display apparatus, and more particularly to a display apparatus capable of reducing power consumption without compromising brightness.

2. Description of the Related Art

A liquid crystal display (LCD) apparatus includes an LCD panel that uses light to generate images. As the LCD panel does not generate light on its own, the LCD panel uses either the light from the environment (e.g., sunlight) or an artificial light source that is optically coupled to the LCD panel.

The amount of light that is supplied to the LCD apparatus affects the brightness of the LCD apparatus. The light supply includes both ambient light and light from a backlight assembly. Thus, when there is sufficient light in the environment, the LCD apparatus can achieve a desired brightness level relying just on the ambient light. However, since the amount of light in the environment is not constant, the LCD apparatus typically includes a backlight assembly to ensure that there will always be a sufficient amount of light supply regardless of time and place. With the backlight assembly, the desired brightness level of the LCD apparatus is maintained at all times.

Although the backlight assembly is indispensable for maintaining a constant brightness level, it has the downside of increasing power consumption. In fact, it is estimated that about 70% of an LCD apparatus' total power consumption is attributed to driving the backlight assembly. Thus, for mobile electric devices such as a cellular phone, a laptop computer, a PDA, etc. that rely on batteries, the presence of a backlight assembly results in the inconvenience of having to charge the batteries more frequently.

This power consumption problem has been addressed by decreasing the electrical power supply to the backlight assembly. However, the decreased power supply results in the brightness level undesirably going down, which is especially problematic when there is not enough ambient light. For these reasons, display apparatus manufacturers are currently unable to satisfy both the consumers' desire for low power consumption and the conflicting desire for high brightness.

A method of reducing the backlight assembly power consumption while maintaining a desired brightness level is desired.

### SUMMARY OF THE INVENTION

The invention provides a method of reducing power consumption without compromising brightness. The invention also provides a display apparatus that conserves power while supplying the desired level of brightness.

According to one aspect of the invention, the brightness of a display apparatus is controlled by sensing an ambient light level, comparing the ambient light level to a reference value to obtain a difference between the ambient light level and the reference value, and adjusting an applied voltage to a light source according to the difference.

Another aspect of the invention is a display apparatus that includes a light source, a sensor for detecting an ambient light level, and a light source driving section for adjusting a brightness of the light source according to the ambient light level.

### BRIEF DESCRIPTION OF THE DRAWINGS

FIG. 1 is a block diagram of an LCD apparatus according to an exemplary embodiment of the present invention;

FIG. 2 is a plan view of the display panel shown in FIG. 1;

FIG. 3 is a cross-sectional view of the display panel shown in FIG. 2;

FIG. 4 is a block diagram of a display apparatus according to another exemplary embodiment of the invention;

FIG. 5 is a graph of transmittance and reflectance as a function of applied voltage;

FIG. 6 is a block diagram of the display panel driving section shown in FIG. 4;

FIGS. 7A and 7B are circuit diagrams showing first and second gamma circuit sections of FIG. 6, respectively;

FIG. 8 is a circuit diagram showing a resistor section for a gray-scale that is built into the data driving section shown in FIG. 6;

FIG. 9 is a cross-sectional view of a first embodiment of an LCD apparatus incorporating the invention;

FIG 10 is a cross-sectional view of a second embodiment of an LCD apparatus incorporating the invention; and

FIG. 11 is a cross-sectional view of a third embodiment of an LCD apparatus incorporating the invention.

### DETAILED DESCRIPTION OF THE INVENTION

Embodiments of the invention are described herein in the context of liquid crystal display (LCD) apparatuses. However, it is to be understood that the embodiments provided herein are just preferred embodiments, and the scope of the invention is not limited to the applications or the embodiments disclosed herein. For example, the invention may be adapted to other types of apparatuses that benefit from a constant light supply.

As used herein, “backlight” is light generated by the backlight assembly, as opposed to “ambient light,” which is light in the environment. The backlight assembly is usually a part of the display apparatus. The position of a backlight assembly is not limited to any particular section of the display apparatus relative to the display panel, as long as the display panel receives light from the backlight assembly. Ambient light may come from a natural source (e.g., the sun) or an artificial source (e.g., a light bulb). As used herein, a “primary light exit surface” refers to the surface of a display panel that affects image brightness most dramatically by having light exit the apparatus through that surface. The primary light exit surface is usually the surface that is closest to a user of the LCD apparatus viewing the displayed images.

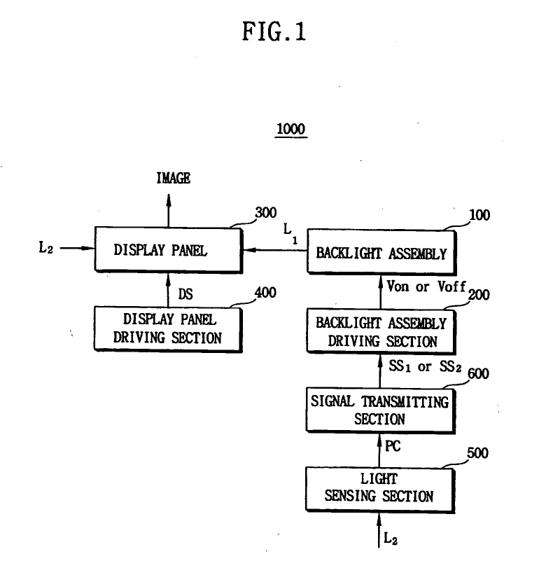

FIG. 1 is a block diagram showing a display apparatus 1000 according to an exemplary embodiment of the invention. The display apparatus 1000 displays images by using a backlight L1 and/or ambient light L2. The display apparatus 1000 includes a backlight assembly 100 for generating the backlight L1, a backlight driving section 200 for controlling the backlight assembly 100, a display panel 300 for displaying images, and a display panel driving section 400 for outputting a driving signal DS for the display panel 300.

The display apparatus 1000 further includes a light sensing section 500, which senses the overall light amount, detects the amount of ambient light, and outputs an electrical signal corresponding to the amount of the ambient light L2. The electrical signal is herein referred to as the photocurrent (PC). Although not shown in the Figures, the light sensing section 500 includes a sensor for sensing the light and a photodetector for detecting the amount of ambient light.

The display apparatus 1000 includes a signal transmitting section 600 for outputting an appropriate electrical signal to the backlight assembly 100 in response to the photocurrent. The signal transmitting section 600 compares the photocurrent output from the light sensing section 500 against a predetermined reference value and determines whether to output a first sensing signal SS1 or a second sensing signal SS2 based on the comparison. The backlight driving section 200 adjusts the voltage V applied to the backlight assembly 100 depending on whether it receives the first sensing signal SS1 or the second sensing signal SS2. The reference value is selected to correspond to a minimum ambient light level that provides a desired brightness level. Thus, if the photocurrent level indicates an ambient light level that is equal to or lower than the light level associated with the reference voltage, the backlight driving section 200 applies a voltage V to the backlight assembly 100 to turn on the backlight assembly 100. In this case, the backlight from the backlight assembly 100 supplements the ambient light to raise the total light amount and achieve the desired brightness level. On the other hand, if the photocurrent level indicates an ambient light level that is equal to or higher than the light level associated with the reference voltage, no backlight is needed to supplement the ambient light. Thus, the backlight driving section 200 applies a voltage V to turn off the backlight assembly 100, thereby conserving power.

The overall effect of the configuration is that the backlight assembly 100 is turned on when supplemental light is desired, and turned off to conserve power the rest of the time. When the ambient light level is below the desired level (i.e., the photocurrent is smaller than the reference value), the backlight driving section 200 turns on the backlight assembly 100 in response to the first sensing signal SS1. Otherwise, the backlight driving section 200 turns off the backlight assembly 100 in response to the second sensing signal SS2. Since the backlight assembly does not have to stay turned on, electrical power consumption for the backlight assembly 100 is reduced.

In some embodiments, the backlight driving section 200 may tune the amount of backlight L1 according to the amount of ambient light L2, instead of simply turning on and turning off the backlight assembly 100. For example, when there is a difference between the reference value and the photocurrent level, the backlight driving section 200 may increase or decrease the voltage V by an amount that corresponds to the difference. If the photocurrent value is higher than the reference value, the backlight driving section 200 may decrease the voltage V that is applied to the backlight assembly 100 by an amount that reflects the difference. Conversely, when the photocurrent is lower than the reference value, the backlight driving section 200 increases the voltage V by an amount that reflects the difference.

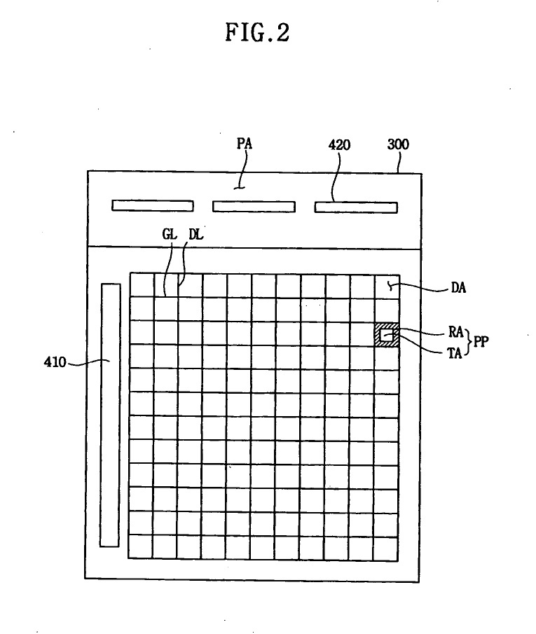

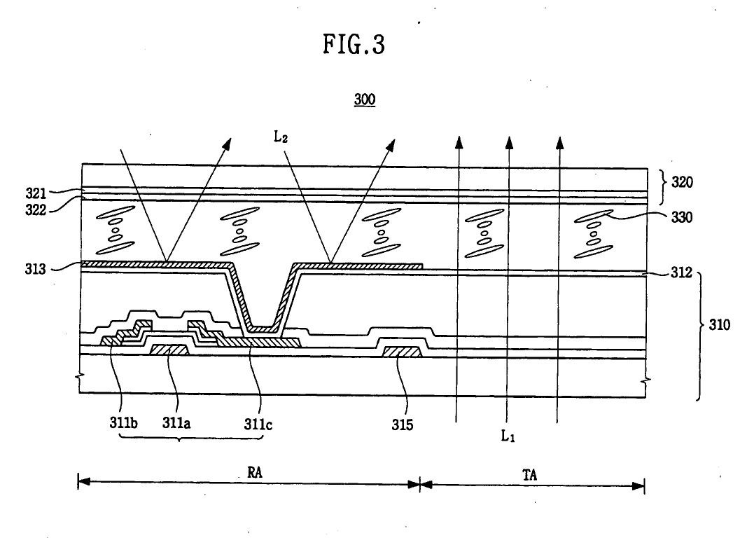

FIG. 2 is a plan view of the display panel shown in FIG. 1. FIG. 3 is a cross-sectional view of the display panel shown in FIG. 3.

Referring to FIGS. 2 and 3, the display panel 300 includes a first member 310, a second member 320 positioned in a plane that is substantially parallel to the first member 310, and a liquid crystal layer 330 disposed between the first and second members 310 and 320. The display panel 300 may be divided into a display area DA for displaying the image and a peripheral area PA adjacent to the display area DA.

A plurality of pixels are formed in a matrix configuration in the display area DA. The first member 310 includes a gate line GL, a data line DL that is substantially perpendicular to the gate line GL, a thin film transistor (TFT) 311 that is connected to the gate lines GL and data lines DL, a transparent electrode 312 connected to the TFT 311 and a reflective electrode 313 coupled to the transparent electrode 312. As shown, the reflective electrode 313 may be formed on the transparent electrode 312. The TFT 311 includes a gate electrode 311a that is connected to the gate line GL, a source electrode 311b that is connected to the data line DL, and a drin electrode 311c that is connected to the transparent electrode 312 and the reflective electrode 313.

The first member 310 further includes a storage electrode 315, which is located to be covered by the transparent and reflective electrodes 312 and 313. An insulating layer is disposed over the storage electrodes 315 and transparent electrode 312 so that the insulating layer covers the storage electrode 315. The storage electrode 315 receives a common voltage.

The second member 320 includes a color filter 321, which imparts red, green, and blue (RGB) colors to the pixels, and a common electrode 322. The common electrode 322 is coupled to the color filter 321 and preferably borders the liquid crystal layer 330.

Hereinafter, an area of the display panel 300 where the reflective electrode 313 is formed is referred to as a “reflective area” (RA) and an area on which the reflective electrode 313 is not formed and the transparent electrode 312 is formed is referred to as a “transmissive area” (TA). The display panel 300 may operate in a transmissive mode and/or in a reflective mode. In the transmissive mode, the display panel 300 displays the image by letting the backlight L1 pass through the transmissive area TA (refer to FIG. 1). In the reflective mode, the display panel 300 displays the image by reflecting the ambient light L2 in the reflective area RA.

The display panel driving section 400, which includes a gate driving section 410 and a data driving section 420, is formed in the peripheral area PA. The gate driving section 410 feeds a gate driving voltage to the gate line GL in response to various control signals from external devices (not shown). Similarly, the data driving section 420 feeds a data voltage to the data line DL.

When the backlight assembly 100 is turned on due to the amount of ambient light L2 being below a desired level, the display panel 300 operates in the transmissive mode using the backlight L1 from the backlight assembly 100. When the backlight assembly 100 is turned off, however, the display panel 300 operates in the reflective mode using primarily the ambient light L2.

When the display panel 300 operates in the transmissive mode using the backlight L1, the transmissive voltage is applied to the transparent and reflective electrodes 312 and 313 through the TFT 311. The display panel 300 displays images in the transmissive area TA using the backlight L1. When the amount of ambient light L2 is below a desired level, the display panel 300 operates in the transmissive mode so that the display panel 300 does not display images in the reflective area RA.

When the display panel 300 operates in the reflective mode using the ambient light L2, the reflective voltage is applied to the transparent and reflective electrodes 312 and 313 through the TFT 311. The display panel 300 displays images in the reflective area RA using the ambient light L2. When the backlight assembly is turned off, the display panel 300 operates in the reflective mode so that the display panel 300 does not display images in the transmissive area TA.

The display panel 300 may operate in the transmissive mode using the backlight L1 or the reflective mode using the ambient light L2, although the transparent electrode 312 is connected to the reflective electrode 313.

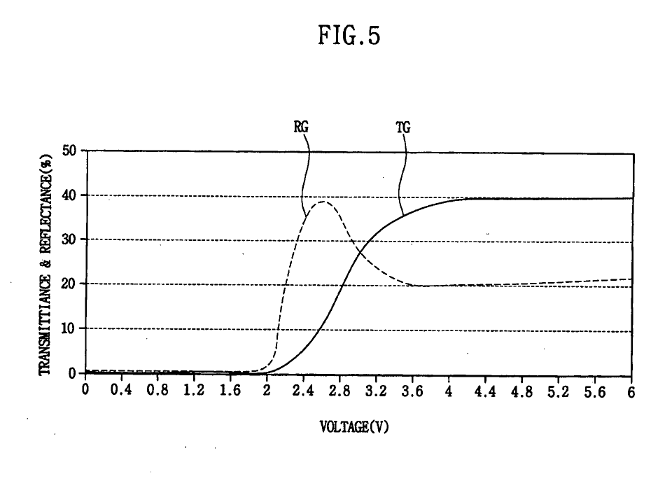

The transmissive and reflective voltages will be described below in reference to FIG. 5.

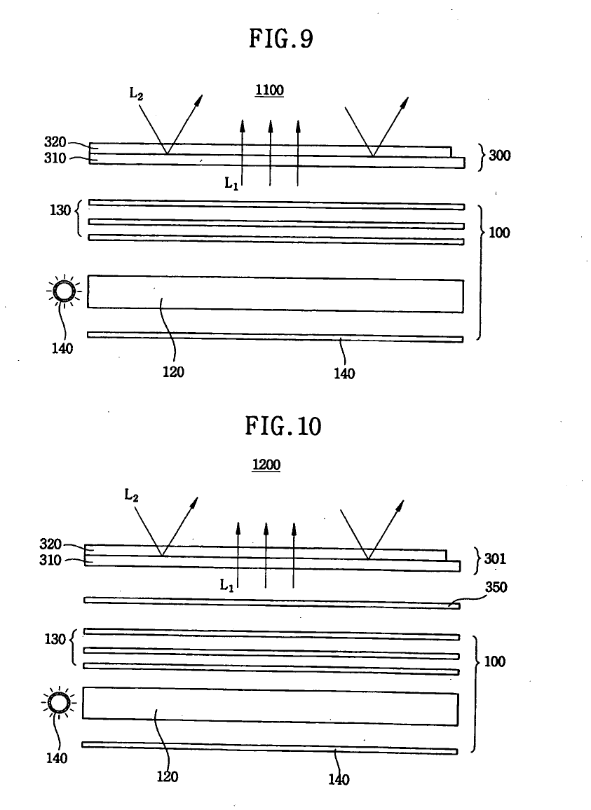

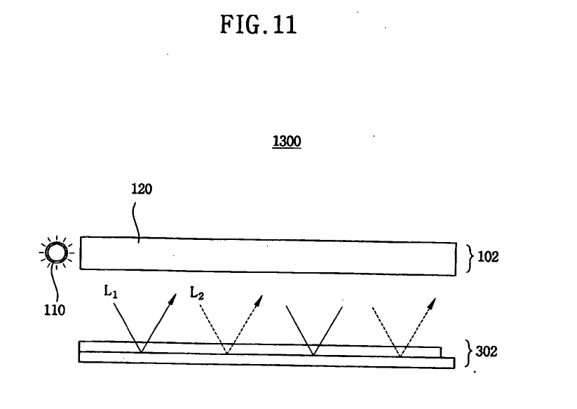

The above exemplary embodiment was illustrated in the context of a transflective-type display panel 300, which has both the transmissive and reflective areas. However, as will be described below in reference to FIG. 10 and FIG. 11, the invention is not limited to a display apparatus using a transflective-type display panel.

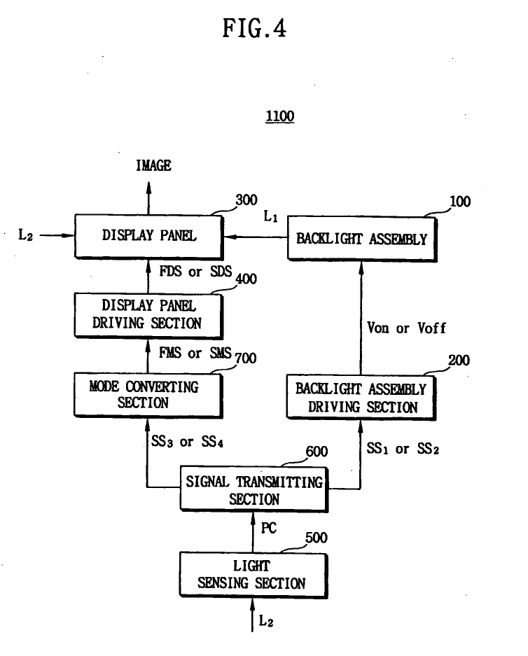

FIG. 4 is a block diagram showing a display apparatus according to another exemplary embodiment of the present invention. Like the embodiment of FIG. 1, this embodiment adjusts the backlight assembly according to the amount of ambient light available. This embodiment, however, also adjusts the gray data voltage and the common voltage of the display panel 300 according to the amount of ambient light. The gray data voltage and the common voltage are adjusted differently depending on whether the ambient light level is sufficient for the apparatus to operate in a primarily reflective mode or insufficient such that the apparatus operates in a primarily transmissive mode.

Unlike the display apparatus 1000 of FIG. 1, the display apparatus 1100 includes a mode converting section 700. As in the display apparatus 1000, the signal transmitting section 600 outputs a first or second sensing signal SS1/SS2. Unlike in the display apparatus 1000, however, the signal transmitting section 600 also outputs a third sensing signal SS3 and a fourth sensing signal SS4 to the mode converting section 700. The mode converting section 700 receives a third sensing signal SS3 and a fourth sensing signal SS4 from the signal transmitting section 600 and outputs either a first mode selecting signal FMS or a second mode selecting signal SMS, depending on the signal that is received. The mode selecting signals FMS, SMS determine the operational mode of the display panel 300. The display panel driving section 400 receives the mode selecting signals FMS or SMS and outputs a first driving signal FDS and a second driving signal SDS in response to the first and second mode selecting signals FMS and SMS, respectively. The display panel 300 displays images according to the driving signal FDS/SDS that is received.

The operational modes of the display panel 300 are the transmissive mode and the reflective mode. In the transmissive mode, the primary light source is the backlight assembly 100. Images are displayed in a transmissive area TA (see FIG. 3) by using the backlight L1 that passes through the display panel 300. The signal transmitting section 600 outputs the third sensing signal SS3 when the photocurrent is smaller than the reference value, for example when the level of ambient light L2 is low. In response to the third sensing signal SS3, the mode converting section 700 outputs the first mode selecting signal FMS to select the transmissive mode.

In the reflective mode, the primary light source is ambient light and images are displayed in a reflective area RA (refer to FIG. 3) by using the ambient light. The signal transmitting section 600 outputs the fourth sensing signal SS4 when the photocurrent is greater than the reference value, for example when there is a lot of ambient light. In response to the fourth sensing signal SS4, the mode converting section 700 outputs the second mode selecting signal SMS to select the reflective mode. The display panel driving section 400, which receives the signals output by the mode converting section 700, operates the display panel 300 in the transmissive mode or reflective mode depending on whether the received signal is the first mode selecting signal FMS or second mode selecting signal SMS.

FIG. 5 is a graph of transmittance (TG) as a function of the transmissive voltage that is applied to the transparent electrode 312 (see FIG. 3) through the TFT 311. The graph also shows the reflectance (RG) when the reflective voltage is applied to the reflective electrode 313 through the TFT 311.

As FIG. 5 shows, when a voltage of about 4.2 volts is applied to the liquid crystal layer 330 (see FIG. 3) in the transmissive area TA, the display apparatus 1000 has a maximum transmittance of about 40%. When a voltage of about 2.6 volts is applied to the liquid crystal layer 330 in the reflective area RA (see FIG. 3), the display apparatus 1000 has a maximum reflectance of about 38%. As illustrated, the applied voltage for achieving the maximum transmittance is different from the applied voltage for achieving the maximum reflectance. Thus, different voltages may be applied to the TFT 311 in the transmissive mode, and the reflective voltage may be applied to the TFT 311 in the reflective mode. In one embodiment, the transmissive voltage is about 4.2V and the reflective voltage is about 2.6V. By applying different voltages to the transmissive area TA and the reflective area RA, the display apparatus 1000/1100 operates at maximum transmittance and maximum reflectance.

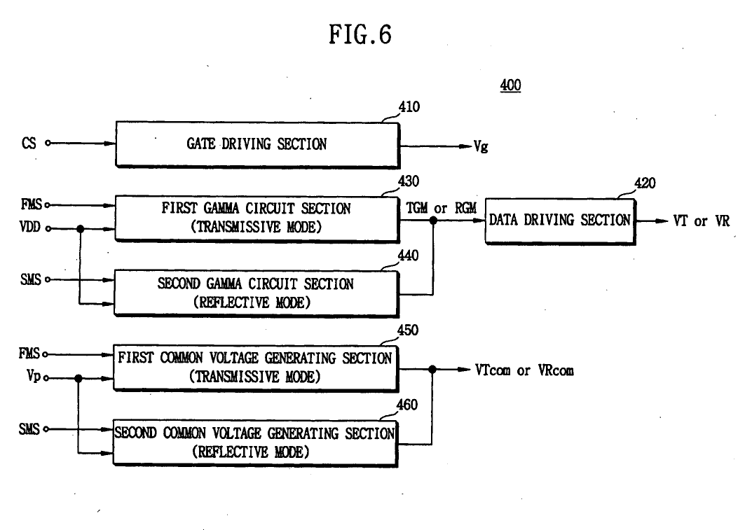

FIG. 6 is a block diagram of a display panel driving section 400 shown in FIG. 1. In addition to the gate driving section 410 and the data driving section 420 shown in FIG. 2, the display panel driving section 400 includes a first gamma circuit section 430, a second gamma circuit section 440, a first common voltage generating section 450, and a second common voltage generating section 460.

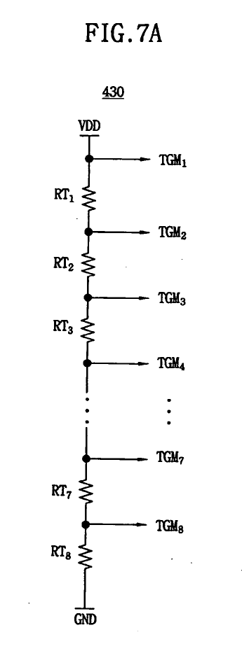

FIGS. 7A and 7B are circuit diagrams of the first and second gamma circuit sections 430,440 shown in FIG. 6.

As shown in FIG. 7A, the first gamma circuit section 430 includes eight resistors, RT1 to RT8, for the transmissive mode connected to each other in series. The eight resistors RT1 to RT8 have resistances suitable for optimizing the transmittance of the transmissive mode as shown in FIG. 5.

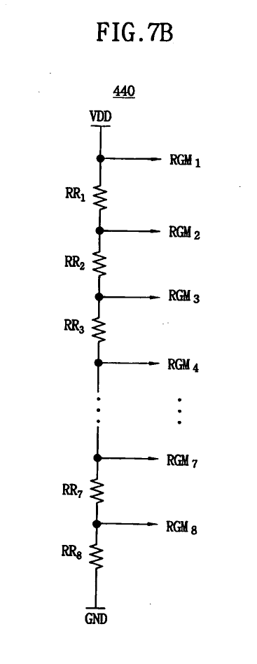

Upon receiving the first mode selecting signal FMS from the mode converting section 700, the first gamma circuit section 430 outputs the electrical potentials of the eight connection nodes as gamma voltages TGM1 to TGM8 for the transmissive mode. The gamma voltages TGM1 to TGM8 are provided to a gray-scale resistor section 421 (see FIG. 8 below), which outputs a gray-scale voltage VT for the transmissive mode that corresponds to the received gamma voltages TGM1 to TGM8.

As shown in FIG. 7B, the second gamma circuit section 440 includes eight resistors RR1 to RR8 for the reflective mode that are connected to each other in series. The eight resistors RR1 to RR8 have resistances suitable for optimizing the reflectance of the display apparatus 1100 shown in FIG. 5. The resistances of resistors RR1 to RR8 may be different from the resistances of resistors RT1 to RT8.

FIG. 8 is a circuit diagram showing a gray-scale resistor section 421 for a gray-scale that is built into the data driving section 420 of FIG. 6. The gray-scale resistor section 421 includes a plurality of resistors connected to each other in series. The number of resistors is a function of the number of gray scales. For example, when the display apparatus 1000 displays the image in 256 (2⁸) gray scales, the gray-scale resistor section 421 includes 256 units of gray-scale resistors connected to each other.

The gray-scale resistor section 421 includes a first terminal to which a first electrical potential (e.g., VDD) is applied and a second terminal to which a second electrical potential (e.g., ground voltage GND) is applied. The gray-scale resistor section 421 shows 256 gray-scale resistors, each of which has a connection node represented by 1^{st} to 256^{th} gray-scale voltages VG₀ to VG₂₅₅. Each connection node for the gray-scale resistors has a different electrical potential from the other connection nodes.

The second gamma circuit section 440 outputs the electrical potentials of the connection nodes associated with the resistors RR1 to RR8. These electrical potentials are gamma voltages for the reflective mode, RGM1 to RGM8, that are generated upon receiving the second mode selecting signal SMS from the mode converting section 700. The gamma voltages RGM1 to RGM8 are provided to the gray-scale resistor section 421. In response to the gamma voltages, the gray-scale resistor section 421 outputs a reflective mode gray-scale voltage VR that corresponds to the received gamma voltage.

As shown in FIG. 6, the first common voltage generating section 450 receives a power voltage Vp from an external source (not shown). The power voltage Vp is constant. If the display panel driving section 400 receives the first mode selecting signal FMS from the mode converting section 700, the first common voltage generating section 450 converts the power voltage Vp to a common voltage VT_{com} and outputs the common voltage VT_{com}. Similarly, if the second common voltage generating section 460 receives the second mode selecting signal SMS from the mode converting section 700, it converts the power voltage Vp to a common voltage for the reflective mode (VR_{com}) and outputs VR_{com}. The first and second voltage generating sections 450, 460 receive the power voltage Vp constantlybut convert it to VT_{com} or VR_{com} in response to the signals FMS/SMS.

The gate driving section 410 outputs a gate driving voltage Vg in response to a control signal CS. The pixels that receive the gate driving voltage Vg receive signals through their data lines DL.

As described above, the display apparatus 1100 switches on/off the backlight assembly 100 based on the amount of the ambient light L2. In response to this switching of the backlight assembly 100, the display apparatus 1100 adjusts the operating mode of the display. When the amount of ambient light L2 is lower than the reference value, the backlight assembly 100 is turned on and the display panel 300 operates primarily in the transmissive mode. On the other hand, when the amount of ambient light L2 is higher than the reference value, the backlight assembly 100 is switched off and the display panel 300 operates primarily in the reflective mode.

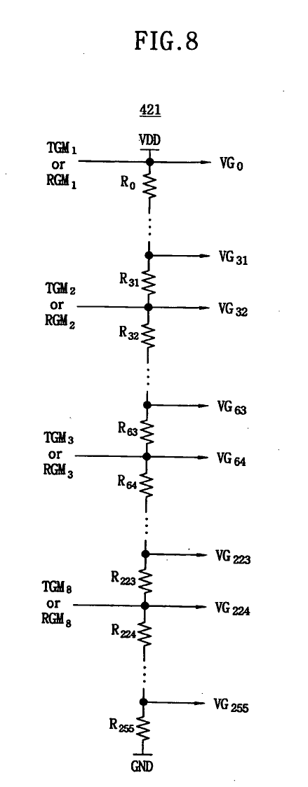

FIGS. 9, 10, and 11 are cross-sectional views of display apparatuses 1100, 1200, and 1300, which are variations of the display apparatus 1000. In each of the embodiments, the primary light exit surface is the surface through which light is shown to leave the apparatus, as indicated by arrows.

The embodiment of FIG. 9 employs the display panel 300 shown in FIG. 3. The display panel 300 has a primary light exit surface 300a. The display apparatus 1100 includes a backlight assembly 100 for generating the backlight L1 and the display panel 300. The backlight assembly 100 and the display panel 300 are coupled such that the display panel 300 is able to use the backlight L1 to display images. The backlight assembly 100 includes a lamp 110 for generating the backlight L1 and a light guiding plate 120 for guiding the backlight L1 to the display panel 300.

The “lamp 110,” which is also referred to herein as the “light source,” may be implemented with one or more of any well-known light source such as LED, fluorescent, phosphorescent, or incandescent light source. The light guiding plate 120 has a planar shape. The light guiding plate receives the backlight L1 through a side surface and guides the received light to the display panel 100. A reflecting plate 140 is disposed near the light guiding plate 120 to reflect any light that leaks from the light guiding plate 120 back toward the display panel 300. One or more optical sheets 130 are positioned between the light guiding plate 120 and the display panel 300 to enhance the brightness of the light coming from the light guiding plate 120. The optical sheets 130 also improve the viewing angle of the display apparatus 1100.

As described above in reference to FIG. 3, the display panel 300 includes a first member 310, a second member 320, and a liquid crystal layer (not shown) disposed between the first and the second members 310 and 320. As shown in FIG. 3, the first member 310 is divided into a reflective area RA and a transmissive area TA. The display panel 300 may operate in a transmissive mode or in a reflective mode, depending on whether the primary light source is backlight L1 or ambient light L2. In the transmissive mode, the display panel 300 displays images by using primarily the backlight L1 from the backlight assembly 100. In the reflective mode, the display panel 300 displays images through the reflective area RA by using the ambient light L2. In embodiments that allow both transmissive and reflective modes to operate simultaneously, the primary light source may be the backlight assembly 100 any ambient light may be reflected to contribute to the brightness, or vice versa.

The display apparatus 1100 switches the backlight assembly 100 on or off based on the amount of the ambient light L2. Further, the display panel 300 switches between the transmissive mode and the reflective mode depending on whether the backlight assembly 100 is on or off. By adjusting the state of the backlight assembly 100, the overall power consumption of the display apparatus 1100 is reduced compared to the conventional embodiments where the backlight assembly 100 has a constant state. Since the state of the backlight assembly 100 depends on the amount of ambient light L2 that is available, this power conservation is achieved without compromising the brightness of the display apparatus 1100.

FIG. 10 shows an LCD apparatus 1200 that includes the backlight assembly 100, a transmissive display panel 301, and a reflective/transmissive film 350 for transmitting the backlight L1 and reflecting the ambient light L2. The transmissive display panel 301 has a primary light exit surface 301a.

Like the display panel 300, the display panel 301 includes a first member 310, a second member 320, and a liquid crystal layer (not shown) disposed between the first and second members 310 and 320. However, unlike the transflective display panel 300, the transmissive display panel 301 has a transparent electrode but no reflective electrode. Instead of the reflective electrode, the LCD apparatus 1200 includes the reflective/transmissive film 350. The reflective/transmissive film 350 is disposed between the display panel 301 and the backlight assembly 100 to transmit the backlight L1 coming from the backlight assembly 100 and reflect the ambient light L2. The reflective/transmissive film 350 is well known and commercially available. For example, Dual Brightness Enhancement Film (DBEF) made by 3M may be used as the reflective/transmissive film 350.

When there is an insufficient amount of ambient light L2, the transmissive display panel 301 operates in the transmissive mode. In the transmissive mode, images are displayed with the backlight L1 that is transmitted through the reflective/transmissive film 350. When there is a sufficient level of ambient light L2, however, the display panel 301 switches to the reflective mode and the lamp 110 is turned off. Thus, the images are displayed by reflecting the ambient light L2 with the reflective/transmissive film 350.

The LCD apparatus 1200 switches the backlight assembly 100 on or off according to the amount of the ambient light L2. Thus, the backlight assembly 100 does not stay turned on and power is conserved. At the same time, since the backlight assembly 100 turns on to supplement the ambient light L2 when the amount of ambient light L2 is insufficient, the desired level of brightness can be achieved for the LCD apparatus 1200 regardless of the amount of ambient light L2.

FIG. 11 shows an LCD apparatus 1300 that includes a backlight assembly 102 for generating the backlight L1 and a reflective display panel 302 for displaying images. The reflective display panel 302 has a primary light exit surface 302a. Like the display panels 300 and 301 described above, the display panel 302 may display images by using either the backlight L1 or the ambient light L2. Unlike the display panels 300 and 301, however, the reflective display panel 302 has only a reflective electrode and no transparent electrode. Thus, the display panel 302 operates in a reflective mode regardless of whether the light is the ambient light L2 or the backlight L1.

In contrast to the LCD apparatuses 1100 and 1200, where the backlight assembly 120 is located on the side of the display panel 300/301 that does not include the primary light exit surface 300a/301a, the backlight assembly 102 is positioned on the side of the display panel 302 that includes the primary light exit surface 302a. Although the light sensing section 500 is continuously sensing the amount of ambient light, the voltage of the backlight assembly 100 is not continuously adjusted. The backlight assembly 101 is switched on only when the amount of the ambient light L2 falls below a predetermined level. As explained above in reference to FIGS. 1 and 4, the amount of ambient light L2 dropping below a predetermined level causes the photocurrent value to become lower than a reference value. When the photocurrent value is lower than the reference value, the backlight assembly 101 is switched on. The backlight assembly 102 turning on achieves a desired brightness level for the display panel 302. The backlight assembly 102 is turned off when the amount of ambient light L2 is higher than the reference value.

When measuring the amount of ambient light L2, the amount of backlight L1 emitted from the backlight assembly 102 is taken into consideration. In an embodiment where a light sensing section (not shown) that senses the amount of ambient light L2 is built into the display panel 302, the light sensing section receives the backlight L1 with the ambient light L2. The light sensing section subtracts the amount of backlight L1 from the total amount of light sensed by the light sensing section to determine the amount of the ambient light L2. The amount of backlight L1 is predetermined.

In summary, the sensing section outputs the sensing signal in response to the amount of the ambient light that is available to the display panel. The backlight driving section turns on or turns off the backlight assembly that provides the backlight to the display panel in response to the sensing signal.

Accordingly, when the amount of ambient light is greater than a predetermined amount, the display panel displays images by using the ambient light and the backlight assembly is turned off. On the other hand, when the amount of the ambient light is less than the amount corresponding to the reference value, the display panel displays images using the backlight that is provided by the backlight assembly. Since the backlight assembly does not remain turned on, the LCD apparatus can operate with a lower power consumption.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A method of controlling a brightness of a display apparatus, the method comprising:
sensing an ambient light level;
comparing the ambient light level to a reference value to obtain a difference between the ambient light level and the reference value; and
adjusting an applied voltage that is applied to a light source according to the difference.

2. The method of claim 1, wherein adjusting the applied voltage comprises turning on the light source if the ambient light level is lower than the reference value and turning off the light source of the ambient light level is higher than the reference value.

3. The method of claim 1, wherein adjusting the applied voltage comprises tuning the applied voltage to achieve a predetermined total light amount that is indicated by the reference value, wherein the total light amount is a combination of the ambient light and light from the light source.

4. The method of claim 1, wherein adjusting the applied voltage comprises changing the applied voltage by a voltage amount that correlates to the difference.

5. The method of claim 1, wherein the reference value corresponds to a given amount of ambient light level.

6. The method of claim 1 further comprising selecting an operating mode of a display panel according to the ambient light level.

7. The method of claim 6, wherein the operating mode is either a transmissive mode whereby light for the brightness is supplied primarily by the light source, or a reflective mode where the light for the brightness is primarily ambient light.

8. The method of claim 7 further comprising:
selecting a gamma voltage based on the ambient light level; and
determining a gray voltage for a display panel in the display apparatus according to the selected gamma voltage.

9. The method of claim 7 further comprising applying a different common voltage to the display apparatus depending on the operational mode.

10. A display apparatus comprising:
a light source;
a sensor for detecting an ambient light level; and
a light source driving section for adjusting a brightness of the light source according to the ambient light level.

11. The apparatus of claim 10, wherein the light source driving section tunes the brightness by changing a voltage applied to the light source by a voltage amount determined by a difference between the ambient light level and a reference value.

12. The apparatus of claim 10, wherein the sensor generates an electrical signal indicating the ambient light level and the driving section turns the light source on or off depending on the electrical signal.

13. The apparatus of claim 10 further comprising:
a display panel positioned to receive light from the light source; and
a display panel driving section for controlling the display panel.

14. The apparatus of claim 13, wherein the sensor generates an electrical signal indicating the ambient light level, the display panel driving section comprising:
a set of gamma circuit sections for selecting a gamma voltage based on the electrical signal; and
a data driving section that converts the gamma voltage to a gray voltage to be applied to a data line of the display panel.

15. The apparatus of claim 14, wherein at least one of the gamma circuit sections comprises:
a first node at a first electrical potential;
a second node at a second electrical potential; and
a plurality of resistors connected in series between the first node and the second node to form intermediary nodes between two consecutively connected resistors, wherein selecting the gamma voltage includes selecting one of the intermediary nodes.

16. The apparatus of claim 15, wherein the set of gamma circuit sections comprises:
a first gamma circuit section for selecting a gamma voltage in a transmissive mode; and
a second gamma circuit section for selecting a gamma voltage in a reflective mode;
wherein the plurality of resistors in the first gamma circuit section have different resistances from the plurality of resistors in the second gamma circuit section.

17. The apparatus of claim 14, wherein the data driving section comprises a plurality of gray-scale resistors connected in series between two nodes, wherein the gamma voltage is coupled to a node between the two nodes for generating a gray voltage.

18. The apparatus of claim 10, wherein the sensor generates an electrical signal indicating the ambient light level and the display panel driving section comprises:
a first common voltage generating section for generating a transmissive mode common voltage in response to the electrical signal; and
a second common voltage generating section for generating a reflective mode common voltage in response to the electrical signal.

19. The apparatus of claim 18, wherein generating the transmissive mode common voltage and generating the reflective mode common voltage each comprises:
receiving a power voltage; and
converting the power voltage according to the electrical signal.

20. The apparatus of claim 10 further comprising a display panel that is positioned to receive light from the light source, the display panel having a transmissive area and a reflective area such that light from the light source exits the apparatus by passing through the transmissive area and ambient light exits the apparatus by reflecting from the reflective area.

21. The apparatus of claim 10 further comprising:
a display panel that is positioned to receive light from the light source, wherein the display panel has a transmissive area through which light from the light source exits the apparatus; and
a reflective-transmissive film positioned between the light source and the display panel.

22. The apparatus of claim 10 further comprising a display panel that is positioned to receive light from the light source, wherein the display panel has a reflective surface for reflecting light from the light source and ambient light out of the apparatus.
